(19) United States
(12) Patent Application Publication
(10) Pub. No.: US 2004/0000183 A1
(43) Pub. Date: Jan. 1, 2004

(54) Crimping pliers with adjustable crimping gauge

(76) Inventors: Edgar Wilhelm, Altersbach (DE); Horst Hofmann, Unterschonau (DE)

Correspondence Address: COLLARD & ROE, P.C., 1077 Northern Boulevard, Roslyn, NY, 11576-1696, US

(21) Appl. No.: 10/042,726

(22) Filed: Jun. 27, 2002

(51) Int. Cl. B25B 7/12

(52) U.S. Cl. 72/409.1

(57) ABSTRACT

The invention relates to crimping pliers with an adjustable crimping gauge, in connection with which the crimping punches acting on the crimping contacts can be driven into and out of the crimping position by a pivoting plunger that guides the crimping punches and is actuated by the movable handle of the pliers and is guided in a curved body.

The problem is based on employing on the crimping pliers an adjusting and setting device using a gauge mandrel, which permits adjusting the crimping gauge with high precision to any size of contacts.

This problem is solved by a setting mechanism formed by a setting spindle, a setting wheel and a scale and arranged on the fixed leg 8 of the pliers in a stationary manner.

The invention relates to crimping pliers with an adjustable crimping gauge, in connection with which the crimping punches acting on the crimping contacts can be driven into and out of the crimping position by a pivoting plunger. This plunger guides the crimping punches and is actuated by the movable handle of the pliers and is guided in a curved body.

Crimping pliers of this type, i.e. those in connection with which the crimping punches for crimping contact pins and/or contact bushes are arranged in a pivoting plunger that is arranged in the head part of the pliers with rotational or pivoting mobility, and driven into the crimping position by a curved body enclosing the crimping punches in a guiding manner, require for each punch a gauge for adjusting the crimping measurement desired or required in the given case, such measurement depending on the cross section of the conductor. Such a gauge, which is usually provided in the form of an adjusting mandrel, has to be made available in this connection for all adjustment measurements of the crimping mandrels. This means that an arsenal of gauge mandrels has to be kept available for each pair of crimping pliers, so that the pliers can be adjusted and set to the desired crimping measurement with the required accuracy to gauge.

This is costly, on the one hand, and also not useful, on the other, because the work with and the handling of such tools is complicated, will easily lead to errors, and, furthermore, requires that the work is carried out with great carefulness.

Setting and adjusting devices in the form of set screws and/or lever elements have already been provided on the crimping pliers of the type that are known in the market and considered here as well, which are the so-called four-mandrel crimping pliers. The curved body, which is provided with control cams, can be relatively pivoted with the help of such screws or lever elements in order to determine and adjust in this way the setting and work path of the crimping punches.

Such setting and adjusting devices do not work in a satisfactory manner for the high requirements currently to be met in the industry using such tools because it is difficult and costly to realize with such devices an exactly dimensioned crimping measurement.

The purpose and the technical problem of the present invention result from the circumstances outlined above.

The purpose is to simplify the adjustment and setting of the pair of crimping pliers to the given required crimping measurement under the handling aspect, and, furthermore, to save those costs that are incurred when a great number of adjusting mandrels have to be made available.

The invention is based on the problem of employing on the pair of crimping pliers an adjusting and setting device using only one gauge mandrel that permits the crimping rate to be adjusted for any size of contacts with high accuracy, i.e. down to a unit of measurement of one hundredth part of a millimeter (1/100), so that the higher crimping accuracy increasingly required predominantly in the field of electronics can be assured.

This problem is solved according to the invention with the technical means characterized in the independent claim, whereby useful special features are explained in the dependent claims.

Versus the known and currently practiced state of the art in the field of cable crimping with the help of crimping pliers, in particular of the type employing the four-mandrel principle, the technical solution as defined by the invention offers welcome benefits because it has not been possible heretofore to realize the desired pressing or crimping process for contact pins and contact bushes with the aforementioned adjustment accuracy of 1/100mm.

The means of the adjusting and setting means, which are employed in a useful manner, as well as their very simple handling in the practical application by the user, speak for itself with respect to the perfection of the functional properties of use of such crimping pliers achieved with the proposal according to the present invention.

The invention is briefly explained in the following in detail with the help of an exemplified embodiment. In the associated drawing,

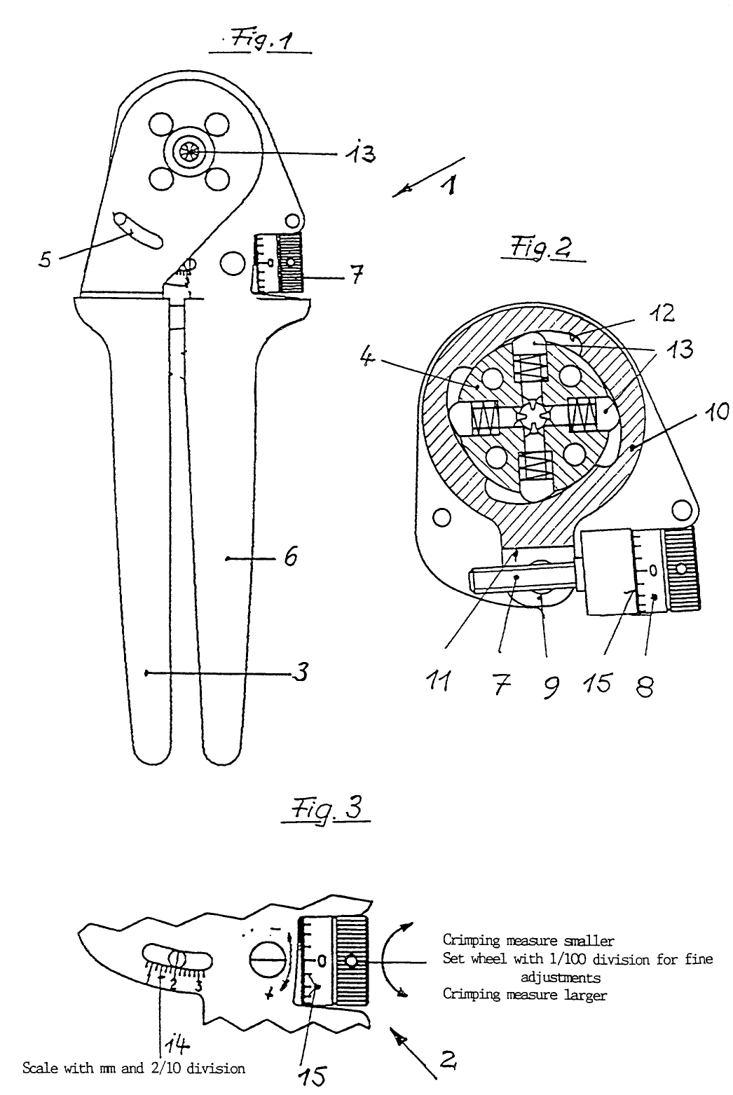

FIG. 1 shows the front view of a four-mandrel pair of pliers in the closed condition.

FIG. 2 shows a section through the head part of the pliers in the plane of the pivoting plunger and curved body with the important adjusting components; and

FIG. 3 shows an enlarged part view of the adjusting and setting components according to FIG. 1, including explanations pertaining to their handling.

The crimping pliers 1 with the adjusting and setting device 2 installed according to the invention, is comprised of a movable pliers leg 3 with the pivoting plunger 4 and the usually fitted, not shown ratchet for controlling the closure of the pliers, as well as an opening limitation 5, and a fixed pliers leg 6, on which the adjusting and setting device 2 is installed in a fixed manner.

The adjusting and setting device 2 is comprised of the threaded spindle 7 with the setting wheel 8, and is connected by a threaded bush 9 with an arm component 11 associated with the curved body 10, in a manner such that when the setting wheel 8 is rotated via the threaded spindle 7, the curved body 10 is pivoted in the one or other direction in relation to the pivoting plunger 4.

Due to the pivotal movements, the control cams 12 of the curved body 10, which each are designed with the same pitch, a correspondingly dimensioned work path is made available for the crimping punches 13 at the same opening angle of each of the pliers legs 3 and 6. This makes it possible to realize differently dimensioned crimping depths according to the adjustment rates in the given case.

Before the pliers is employed by the user, it is pre-adjusted and set in the manufacturer's plant, so that the user only needs to make the adjustment to the desired crimping measurement, thus the crimping depth according to an associated adjustment matrix. The scales shown in FIGS. 2 and 3 for rough and fine adjustments to crimping measurements of 1/100mm accuracy serve for such adjustments.

The crimping pliers 1 is pre-adjusted and set and the setting wheel 8 is thus set at the same time as follows:

With the help of a gauge mandrel with a diameter of, for example 2 mm, which has been loosely inserted in the centric crimping opening, the measurement of 2 mm is adjusted with the setting wheel 8 according to scale 14. The setting wheel 8 has to be actuated for this purpose in a delicately sensitive manner. The graduated scale 15 of the set wheel 8 is subsequently set to zero and the pliers is closed (FIG. 3).

With such an adjustment, it still has to be possible to move the gauge mandrel, 2 mm diameter, between the crimping tips of the crimping punches 13 without play. If, for example, this is not immediately possible, the dimensional deviation (+/−) is determined and compensated via the fine adjustment on the graduated scale 15, and after the threaded spindle 7 has been temporarily loosened, the setting wheel 8 is set to zero, and subsequently fixed again in a suitable manner, for example with the help of an index screw.

In deviation from the exemplified embodiment specified above, the adjusting and setting device may be installed also on the movable leg of the pliers, which would not impair its functionality in any way.

A locator, for example 12, usefully may be provided for the crimping pliers as a helpful aid. Such a locator can be rotated by 360° and is capable of receiving, in a manner determining the position, different contact designs depending on their type and size.

The crimping measure and the locator adjustments can be fixed and preset depending on the contact with the help of a matrix designed accordingly.

1. A crimping pliers with an adjustable crimping gauge, in connection with which the crimping punches acting on the crimped contact can be jointly moved centrally and in the radial plane by a pivoting plunger actuated by the movable handle of the pliers, and driven into and out of the pressing or crimping position, characterized by the following features:
The curved body (10) arranged in the head part of the crimping pliers (1) in the generally known manner and enclosing the pivoting plunger (4), supports an arm component (11) cantilevered in the direction of the handles of the pliers.
On said arm, a setting spindle (7) is articulated in a stationary, threaded bush (9) transversely extending through the arm component (11), whereby upon actuation of said setting spindle, the curved body (10) can be pivoted in both directions.
The setting spindle (7) supports a setting wheel (8) with a vernier or scale (15) for fine adjustments, and is arranged in a stationary manner in the fixed leg (6) of the pliers; whereas, furthermore,
a scale (14) for rough adjustments is attached to the fixed leg (6) of the pliers as well as to the curved body (10), in each case within the range of the setting spindle (7).

2. The crimping pliers according to claim 1, characterized in that the scale for fine adjustments has a 1/100mm division, and the scale (14) for rough adjustments has a 2/10mm division.

3. The crimping pliers according to claim 1, characterized by the combination with a multi-component locator having a basically known construction.
